(19) United States
(12) Patent Application Publication
(10) Pub. No.: US 2004/0117832 A1
(43) Pub. Date: Jun. 17, 2004

(54) Method of switching channels in a receiver, especially in a digital television receiver

(75) Inventor: Tomasz Kozlowski, Zielona Gora (PL)

Correspondence Address: ORRICK, HERRINGTON & SUTCLIFFE, LLP, 4 PARK PLAZA, SUITE 1600, IRVINE, CA, 92614-2558, US

(73) Assignee: Advanced Digital Broadcast, Ltd and Advanced Digital Broadcast Polski sp. zo.o

(21) Appl. No.: 10/728,633

(22) Filed: Dec. 5, 2003

(30) Foreign Application Priority Data
Dec. 6, 2002 (PL) P 357587

(51) Int. Cl. G06F 13/00; H04N 5/445; G06F 3/00

(52) U.S. Cl. 725/61; 725/37; 725/38; 725/52

(57) ABSTRACT

The method of switching channels in a receiver, especially in a digital television receiver in which groups are assigned to channels, characterized in that the channel is manually chosen, a switching takes place to receive the selected channel, the previously active group is deactivated by means of the control signal, the group assigned to the selected channel is activated, and next with the use of the switching function, the next or previous channel is selected, and after this the next or the previous channel, which belongs to the currently active group, is searched and by means of control signal the receiver is set to receive this channel.

### CROSS REFERENCE TO RELATED APPLICATIONS

The subject application claims priority to Polish patent application No. P-357587, filed Dec. 6, 2002.

### BACKGROUND

The object of the invention is a method of switching channels in a television receiver, especially a digital television receiver, in which separate channels have subject groups, language groups or other groups assigned to them.

There is a method of assigning numbers of logical channels to physical channels received by a decoder of digital television, known from a description of Polish application of invention P-356982, which is specifically incorporated by reference herein. In this method, channels are assigned to language groups. Information about the assignment of a channel to a group is used only to set the numbering of logical channels.

### SUMMARY OF THE INVENTION

The method of servicing lists and sublists of channels, available in a multimedia vision decoder, is described in U.S. Pat. No. 6,182,287, which is specifically incorporated by reference herein. In the method presented in this patent description, a change from one subject list to another one, requires selecting appropriate function from the menu.

The method of switching channels in the television receiver, especially in a digital television receiver, in which groups are assigned to channels, according to the invention, is characterized in that the channel is manually chosen. By means of the control signal, the television receiver is switched to reception of the chosen channel, the previously active group is deactivated, and the group assigned to the chosen channel is activated. Next, by means of a function switching to the next or previous channel, the next or the previous channel, which belongs to the currently active group, is searched, and by means of the control signal, the television receiver is switched to receive this channel.

It is favorable that the type of groups, which are to be activated, is defined and that the channel is manually selected.

It is favorable that by means of the control signal the television receiver is set to receive the selected channel, and next the previously active group is deactivated, and the group of a specific type, assigned to a specific channel, is activated.

It is favorable that the channel is manually selected, a list of groups assigned to this channel is created, and from the list a group is selected, which is assigned to be activated.

It is favorable that channels not assigned to any group are added to the group of channels, which belong to active groups.

It is favorable that, by means of the control signal, upon a change to receive a specific channel, the name of the group to which this channel belongs, is simultaneously displayed on the television screen or monitor.

According to the invention, a modification of the method of switching channels in a television receiver, especially in a digital television receiver, in which groups are assigned to channels, is characterized in that a list of active groups is defined. By means of the switching function, the next or the previous channel is searched, which belongs to the list of active groups, and by means of control signals the television receiver is switched to this channel.

In a favorable variant of the modification of the method, reception of the specific channel is switched by means of the control signals, and simultaneously, the name of the group to which this channel belongs is displayed on the television screen.

According to the invention, two methods of switching the channels in the television receiver contribute to simplification of servicing the activation of subject groups, language groups, or other groups. In a comfortable way for the user, one or more groups, assigned to the channels in the television receiver, can be set as active groups. The procedure of switching channels between the groups is easy, with a precisely defined subject range or language. Application of switching function P+/P− causes switching channels only within the framework of the active group, omitting channels, which do not belong to this group. Moreover, the presented method greatly facilitates the procedure of activating groups and switching between channels which belong to the active group.

### DESCRIPTION OF THE DRAWINGS

FIG. 1 shows a diagram of basic activities, by means of which channels are switched in television receiver.

FIG. 2 shows a diagram of activities in the procedure assigned to the system, in which only one group is assigned to each channel

FIG. 3 shows a diagram of activities in the procedure, servicing a single group with a defined type.

FIG. 4 shows a diagram of activities in the procedure handling a single group with a changeable type.

FIG. 5 shows a diagram of activities in the procedure handling a fixed collection of groups.

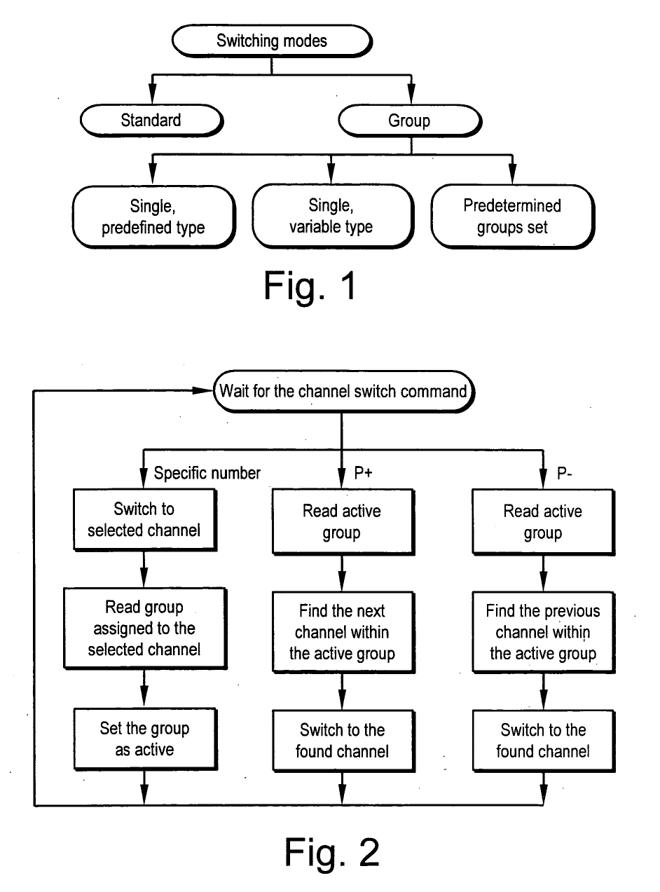

### DETAILED DESCRIPTION OF THE INVENTION

If only one group is assigned to each channel, the procedure of switching channels is started from manual input of the number of a specific channel, appropriately to the requirements of the user. The television receiver is switched to receive a selected channel by means of the control signal. A group assigned to this channel is read from the memory. This group is set as an active group. In this moment, the group, which earlier was an active group, is deactivated, and simultaneously, the group assigned to the selected channel is activated. Referring to FIG. 2, the use of the P+/P− switching function is shown whereby switching to the next or previous channel causes the control signal to be sent, which is followed by searching for the next or the previous channel, belonging to the currently active group, and next switching the television receiver to reception of this channel.

The information stored in the memory about the active group can have a form of:

active_group={sort}

If the user selected the option of switching P+ (switching to the next channel), the procedure automatically reads the currently active group. Next, in the table of grouping channels, the next channel, which belongs to this group, is searched forward. In case the search procedure comes to the end of the list of grouping channels, it continues searching it forward from its beginning. After the right channel is found, the television receiver is switched to reception.

If the user has selected the option of switching function P− (switching to the previous channel), the procedure automatically reads the currently active group. Next, in the table of grouping channels, the previous channel, which belongs to this group, is searched back. If after searching the procedure comes to the beginning of the table of grouping channels, it continues searching back from its end. After finding the appropriate channel, it switches the television receiver to reception of this channel.

If there is one or more groups assigned to one channel, the option of the procedure of switching channels in the television receiver in the mode of a single group with a defined type can be used.

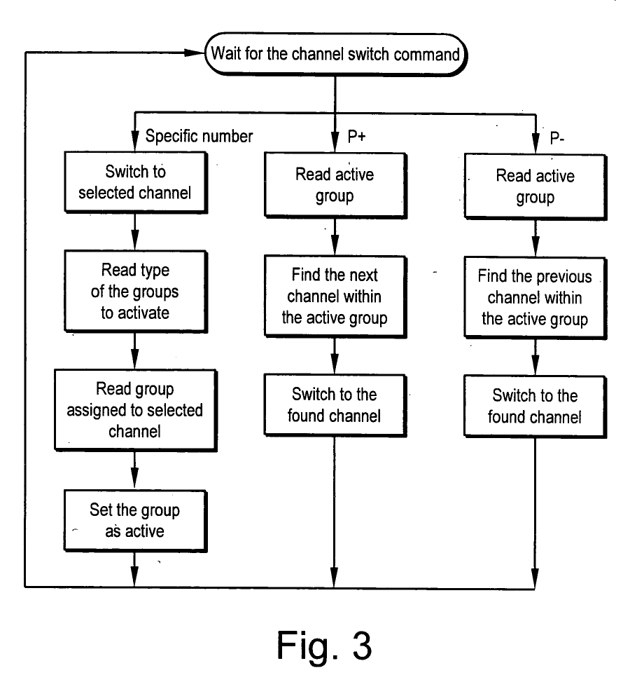

Based on the options defined in the television receiver's menu, the type of groups to be active is defined. Referring to FIG. 3, for example, only the language group is defined. After switching to the selected channel, the procedure automatically defines the type of groups which are to be activated (which was earlier set in menu options). Next the group of this type, which is assigned to the selected channel, is read. This group is set as active, at the same time canceling activation of the existing active group.

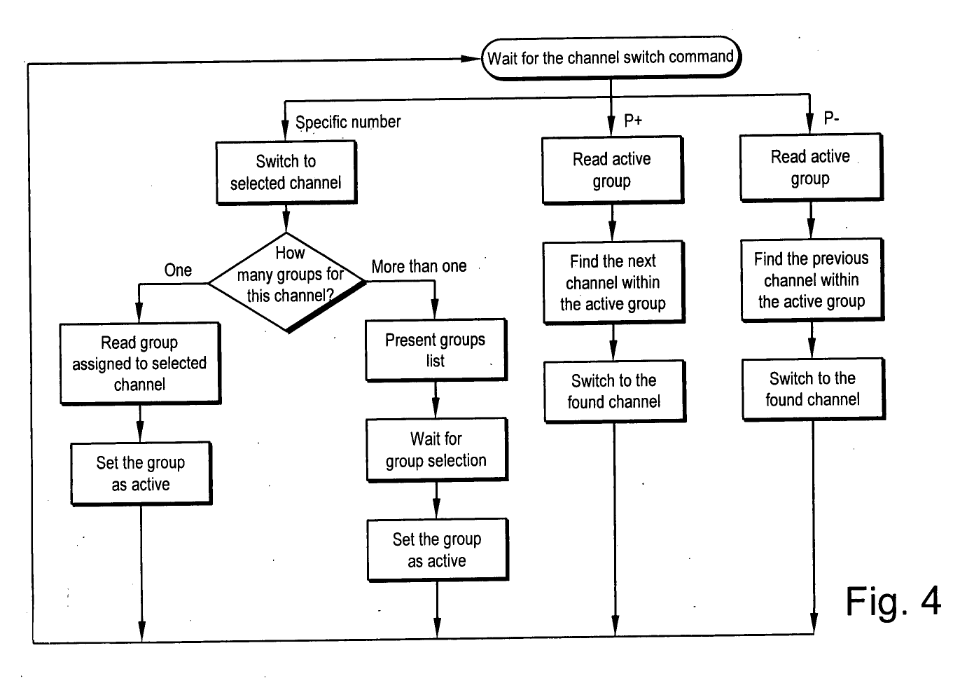

The option to implement the procedure of switching channels in the television receiver in the mode of a single group with a changeable type is based on defining the group which is to be set as active group. Selection of the right group is made on the basis of the list displayed on the television screen or monitor, in which the names of separate groups are given. When choosing a new channel, by manual input of its number, it is checked if one or more groups are assigned to the channel. If one group is assigned to the channel, it is set as an active group by means of the signal of the switch. Referring to FIG. 4, if more groups are assigned to the channel, one group is selected from the list of groups displayed on the screens, which is then activated.

A next variant of the method of switching channel in the television receiver is characterized by switching within the range of a fixed collection of groups. Specifically, using the switching function P+/P−, the content of the list of groups with various types can be set. For example, this list can be defined by means of a specific variable in the storage with the following content:

active_groups {English, Polish, music, news, sports}

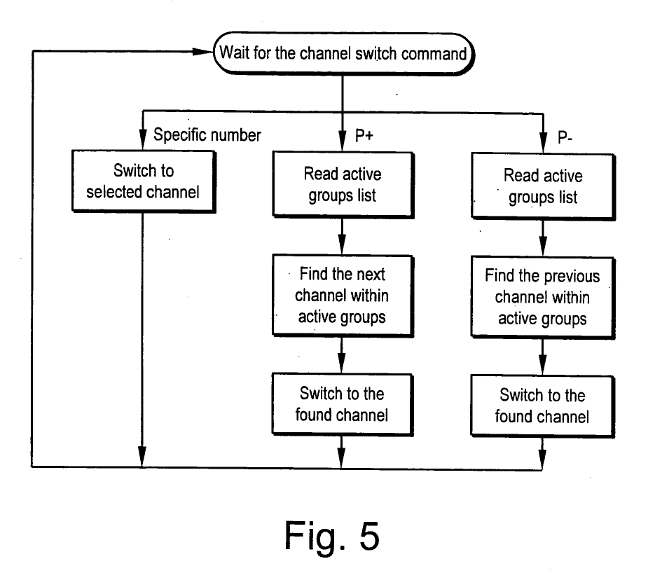

With the use of the function of switching P+/P−, channels to which neither of the set groups is assigned, are omitted. As shown in FIG. 5, selection of any channel can be made by means of manual input of its number. Manual selection of a channel causes a shift to the selected channel, but does not change the settings of the active groups.

Selection of the options of switching function P+ (switching to the next channel) causes a list of active groups to be read. Next, in the table of grouping channels, the next channel is searched forward, which is subordinated to at least one of the groups, located on the list of active groups. In case the search procedure comes to the end of the list of grouping channels, it continues searching it forward from its beginning. After the searched channel is found, the receiver switches to the reception of this channel.

Selection of the option of switching function P− (switching to the previous channel) causes the list of active groups to be read. Next, in the table of grouping channels, the previous channel is searched back, which is subordinated to at least one of the groups located on the list of active groups. In case the searching procedure comes to the beginning of the channel grouping list, it continues searching the channel back from its end. After the searched channel was found, the television receiver is switched to reception of this channel.

In the method of the invention, when the control signal simultaneously switches to receive a selected channel, the name of group to which this channel belongs, is also displayed on the television screen or monitor.

Although the method of switching channels in the receiver was described in relation to the channels of digital television, it is also applicable in other systems, in which channels or services, assigned to groups, are handled, independently of the number of groups, their grouping by subject, and chronology. For example, these may be receivers of analogue television or radio receivers or mobile phones with a liquid crystal display.

The above-mentioned detailed description of separate activities, which enable the method of switching channels in a television receiver according to the invention, should not be interpreted as limiting the inventive subject matter claimed as the varieties of methods and embodiments of the invention. One of ordinary skill in the field of switching channels in a television receiver will appreciate the described varieties of the methods can be subjected to many modifications, adjustments or equal implementations, which will not depart from the spirit of the invention.

What is claimed is:

1. The method of switching channels in a receiver, especially in a digital television receiver in which groups are assigned to channels, characterized in that a channel is manually chosen as a selected channel, a switching takes place to receive the selected channel, a previously active group is deactivated by means of a control signal, a group assigned to the selected channel is activated,
next, with the use of a switching function, a next or previous channel is selected, wherein the next or the previous channel is searched and the receiver is set to receive the next or previous channel by means of the control signal.

2. The method of claim 1 wherein groups to be activated are defined by type of channel is manually selected, the earlier active group is deactivated, and a group of a specific type assigned to the given channel is activated.

3. The method of claim 1 wherein the channel is manually selected and wherein the activated group is selected from a list of groups.

4. The method of claim 1 wherein channels not assigned to any group are added to the group of channels belonging to active groups.

5. The method of claim 1 wherein the control signal simultaneously switches to receive the specific channel and the name of the group to which the channel belongs is displayed on a screen of the receiver.

6. A method of switching channels in a receiver in which groups are assigned to channels, characterized in that a list of active groups are defined, and by means of a switching function, a next or a previous channel belonging to the currently active group is selected, and by means of control signal, the decoder is switched to the next or previous channel.

7. The method of claim 6 wherein channels assigned to any group are added to groups of channels belonging to active groups.

8. The method of claim 6 wherein control signal simultaneously switch to receive a specific channel and the name of the group of the specific channel is displayed on the screen of the receiver.

9. The method of claim 6 wherein the receiver is a digital television receiver.
